(19) United States
(12) Patent Application Publication
(10) Pub. No.: US 2023/0308907 A1
(43) Pub. Date: Sep. 28, 2023

(54) METHODS, DEVICES, AND SYSTEMS FOR CONFIGURING USER EQUIPMENT FOR MINIMIZATION OF DRIVE TEST

(71) Applicant: ZTE Corporation, Shenzhen (CN)

(72) Inventors: Li YANG, Shenzhen (CN); Yan XUE, Shenzhen (CN); Feng XIE, Shenzhen (CN); Yanwei FANG, Shenzhen (CN)

(73) Assignee: ZTE Corporation, Shenzhen (CN)

(21) Appl. No.: 18/205,062

(22) Filed: Jun. 2, 2023

Related U.S. Application Data
(63) Continuation of application No. PCT/CN2021/078997, filed on Mar. 4, 2021.

(51) Int. Cl. H04W 24/02; H04W 64/00

(52) U.S. Cl. CPC H04W 24/02; H04W 64/006

(57) ABSTRACT

The present disclosure describes methods, system, and devices for configuring a user equipment (UE) for minimization of drive test (MDT). One method includes receiving, by a radio access network (RAN) node, a start message from a core network (CN) or an operation and maintain system (OAM). The start message comprising at least one MDT configuration item and optional non-access stratum (NAS) information, the at least one MDT configuration item comprising at least one of the following MDT configuration information: an expected position, an expected mobility profile, an expected velocity, an expected direction, an expected service profile, or an indicator for the UE to sense and report local surroundings; and sending, by the RAN node, a configuration message to the UE, the configuration message, so that the UE performs according to the at least one MDT configuration item and the optional NAS information and reports a MDT measurement result.

### TECHNICAL FIELD

The present disclosure is directed generally to wireless communications. Particularly, the present disclosure relates to methods, devices, and systems for configuring a user equipment (UE) for minimization of drive test (MDT).

### BACKGROUND

Wireless communication technologies are moving the world toward an increasingly connected and networked society. In some previous generation of wireless communications, manual driving test has been used to perform various kinds of driving test against various network associated objects and quantities. This manual driving test is time consuming and costly. In recent developing generations of wireless communications, minimization of drive test (MDT) emerges to replace manual driving test to perform various kinds of driving test of MDT tasks against various network associated objects and quantities and to collect MDT measurement results.

However, there are various problems/issues associated with the present MDT framework. For example but not limited to, one problem/issue may be that the present MDT mechanism framework including a user equipment (UE) capable of MDT may be in a passive role; and/or another problem/issue may be that a UE volunteering for a MDT task may not be selected or configured by the network in a proper service and a mobility context. For example, if no UE with a particular service happens to be in a particular coverage place, the network (NW) may not get the relevant MDT measurement results for this particular coverage place with the particular service; and the NW may only configure and get the relevant MDT measurement results with some other UE with the particular service in another service coverage place if another UE with the particular service happens to be in the another service coverage place. For another example, in a particular coverage place, if there is a UE with a particular service in a particular coverage place and the NW may not select or configure the UE with relevant MDT tasks, NW may miss the relevant MDT measurement results for the particular coverage place with the particular service.

The present disclosure describes various embodiments for configuring a user equipment (UE) for minimization of drive test (MDT), addressing at least one of the problems/issues discussed above. The present disclosure may enhance MDT mechanism and configuration of selecting and configuring UE with various MDT tasks, improving a technology field in the wireless communication.

### SUMMARY

This document relates to methods, systems, and devices for wireless communication, and more specifically, for configuring a user equipment (UE) for minimization of drive test (MDT).

In one embodiment, the present disclosure describes a method for wireless communication. The method includes configuring, by a radio access network (RAN) node, a user equipment (UE) for minimization of drive test (MDT) by receiving, by the RAN node, a start message from a core network (CN) or an operation and maintain system (OAM), the start message comprising at least one MDT configuration item, the at least one MDT configuration item comprising at least one of the following MDT configuration information: an expected position for the UE, an expected mobility profile for the UE, an expected velocity for the UE, an expected direction for the UE, an expected service profile for the UE, or an indicator for the UE to sense and report local surroundings; and in response to receiving the start message, sending, by the RAN node, a configuration message to the UE, the configuration message comprising the at least one MDT configuration item, so that the UE performs according to the at least one MDT configuration item and reports a MDT measurement result.

In another embodiment, the present disclosure describes a method for wireless communication. The method includes configuring, by a radio access network (RAN) node, a user equipment (UE) for minimization of drive test (MDT) by receiving, by the RAN node, a start message from a core network (CN) or an operation and maintain system (OAM), the start message comprising at least one MDT configuration item and non-access stratum (NAS) information, the at least one MDT configuration item comprising at least one of the following MDT configuration information: an expected position for the UE, an expected mobility profile for the UE, an expected velocity for the UE, an expected direction for the UE, an expected service profile for the UE, or an indicator for the UE to sense and report local surroundings; and in response to receiving the start message, sending, by the RAN node, a configuration message to the UE, the configuration message comprising the at least one MDT configuration item and the NAS information, so that the UE performs according to the at least one MDT configuration item and the NAS information and reports a MDT measurement result.

In another embodiment, the present disclosure describes a method for wireless communication. The method includes configuring a user equipment (UE) for minimization of drive test (MDT) by receiving, by the UE, a configuration message from a radio access network (RAN) node, the configuration message comprising at least one MDT configuration item, wherein: a core network (CN) or an operation and maintain system (OAM) sends a start message to the RAN node, the start message comprising the at least one MDT configuration item, in response to receiving the start message from the CN or the OAM, the RAN node sends the configuration message to the UE, and the at least one MDT configuration item comprises at least one of the following MDT configuration information: an expected position for the UE, an expected mobility profile for the UE, an expected velocity for the UE, an expected direction for the UE, an expected service profile for the UE, or an indicator for the UE to sense and report local surroundings; and performing, by the UE, according to the at least one MDT configuration item and reporting a MDT measurement result.

In another embodiment, the present disclosure describes a method for wireless communication. The method includes configuring a user equipment (UE) for minimization of drive test (MDT) by receiving, by the UE, a configuration message from a radio access network (RAN) node, the configuration message comprising at least one MDT configuration item and non-access stratum (NAS) information, wherein: a core network (CN) or an operation and maintain system (OAM) sends a start message to the RAN node, the start message comprising the at least one MDT configuration item and the NAS information, in response to receiving the start message from the CN or the OAM, the RAN node sends the configuration message to the UE, and the at least one MDT configuration item comprises at least one of the following MDT configuration information: an expected position for the UE, an expected mobility profile for the UE, an expected velocity for the UE, an expected direction for the UE, an expected service profile for the UE, or an indicator for the UE to sense and report local surroundings; and performing, by the UE, according to the at least one MDT configuration item and the NAS information and reporting a MDT measurement result.

In another embodiment, the present disclosure describes a method for wireless communication. The method includes configuring, by a core network (CN), a user equipment (UE) for minimization of drive test (MDT) by sending, by the CN, a start message to a radio access network (RAN) node, the start message comprising at least one MDT configuration item, the at least one MDT configuration item comprising at least one of the following MDT configuration information: an expected position for the UE, an expected mobility profile for the UE, an expected velocity for the UE, an expected direction for the UE, an expected service profile for the UE, or an indicator for the UE to sense and report local surroundings; and wherein: in response to receiving the start message, the RAN node sends a configuration message to the UE, the configuration message comprising the at least one MDT configuration item, so that the UE performs according to the at least one MDT configuration item and reports a MDT measurement result.

In another embodiment, the present disclosure describes a method for wireless communication. The method includes configuring, by a core network (CN), a user equipment (UE) for minimization of drive test (MDT) by sending, by the CN, a start message to a radio access network (RAN) node, the start message comprising at least one MDT configuration item and non-access stratum (NAS) information, the at least one MDT configuration item comprising at least one of the following MDT configuration information: an expected position for the UE, an expected mobility profile for the UE, an expected velocity for the UE, an expected direction for the UE, an expected service profile for the UE, or an indicator for the UE to sense and report local surroundings; and wherein: in response to receiving the start message, the RAN node sends a configuration message to the UE, the configuration message comprising the at least one MDT configuration item and the NAS information, so that the UE performs according to the at least one MDT configuration item and the NAS information and reports a MDT measurement result.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include a core network, a wireless network node, and one or more user equipment.

FIG. 1B shows a schematic diagram of configuring a user equipment (UE) for minimization of drive test (MDT).

FIG. 2 shows an example of a wireless network node.

FIG. 3 shows an example of a user equipment.

FIG. 4 shows a flow diagram of a method for wireless communication.

FIG. 5A shows an exemplary logic flow of a method for wireless communication.

FIG. 5B shows another exemplary logic flow of a method for wireless communication.

FIG. 6 shows a schematic diagram of various embodiments for configuring a UE for MDT.

FIG. 7 shows another schematic diagram of various embodiments for configuring a UE for MDT.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes various methods and devices for configuring a user equipment (UE) for minimization of drive test (MDT).

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfill the requirements from different industries and users.

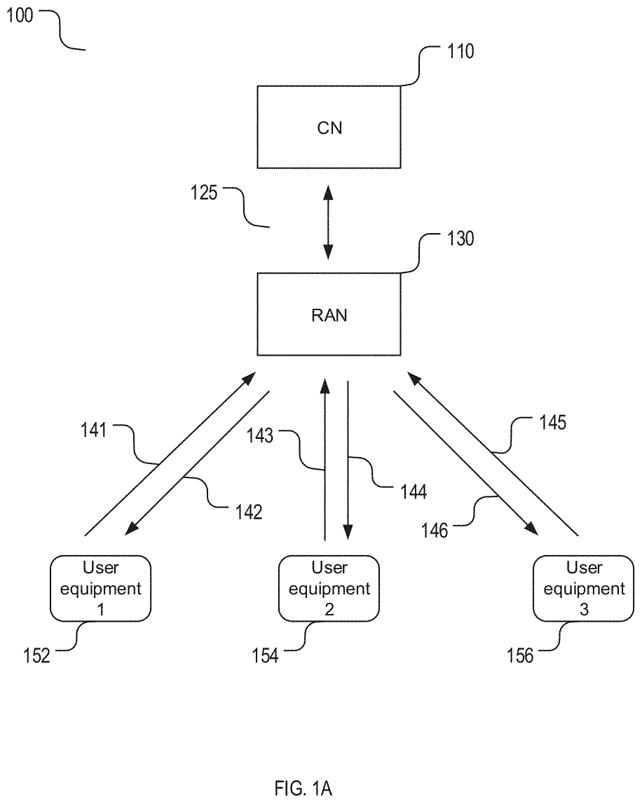

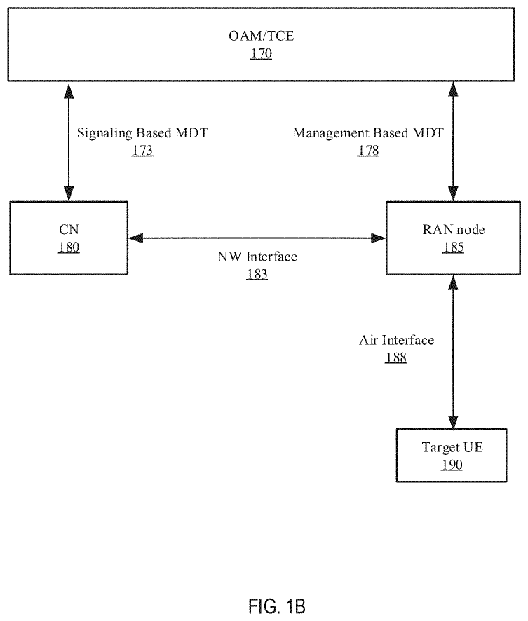

FIG. 1A shows a wireless communication system 100 including a core network (CN) 110, a wireless node 130, and one or more user equipment (UE) (152, 154, and 156). The wireless node 130 may include a wireless network base station, a radio access network (RAN) node, or a NG radio access network (NG-RAN) base station or node, which may include a nodeB (NB, e.g., a gNB) in a mobile telecommunications context. In one implementation, the core network 110 may include a 5G core network (5GC or 5GCN), and the interface 125 may include a NG interface. The wireless node 130 (e.g, RAN) may include an architecture of separating a central unit (CU) and one or more distributed units (DUs).

The communication between the RAN and the one or more UE may include at least one radio bearer (RB) or channel (RB/channel). Referring to FIG. 1A, a first UE 152 may wirelessly receive from the RAN 130 via a downlink RB/channel 142 and wirelessly send communication to the RAN 130 via a uplink RB/channel 141. Likewise, a second UE 154 may wirelessly receive communicate from the RAN 130 via a uplink RB/channel 144 and wirelessly send communication to the RAN 130 via a uplink RB/channel 143; and a third UE 156 may wirelessly receive communicate from the RAN 130 via a uplink RB/channel 146 and wirelessly send communication to the RAN 130 via a uplink RB/channel 145.

In some previous generation of wireless communications, manual driving test has been used to perform various kinds of driving test against various network associated objects and quantities. This manual driving test is time consuming and costly. In recent developing generations of wireless communications, minimization of drive test (MDT) emerges to replace manual driving test to perform various kinds of driving test of MDT tasks against various network associated objects and quantities and to collect MDT measurement results.

However, there are various problems/issues associated with the present MDT framework. For example but not limited to, one problem/issue may be that the present MDT mechanism framework including a user equipment (UE) capable of MDT may be in a passive role; and/or another problem/issue may be that a UE volunteering for a MDT task may not be selected or configured by the network in a proper service and a mobility context. For example, if no UE with a particular service happens to be in a particular coverage place, the network (NW) may not get the relevant MDT measurement results for this particular coverage place with the particular service; and the NW may only configure and get the relevant MDT measurement results with some other UE with the particular service in another service coverage place if another UE with the particular service happens to be in the another service coverage place. For another example, in a particular coverage place, if there is a UE with a particular service in a particular coverage place and the NW may not select or configure the UE with relevant MDT tasks, the NW may miss the relevant MDT measurement results for the particular coverage place with the particular service. In one implementation, the NW may include at least one of CN and/or RAN.

With the latest development of MDT techniques in 3GPP industry field, the NW may select and configure one or more proper UE to perform various kinds of driving test of MDT tasks against various NW associated objects and/or quantities. The NW may collect and retrieve MDT measurement results (e.g., MDT logs) from the one or more participating UE. The NW may optimize itself in various performance aspects, such as radio coverage, radio capacity, service parameter setting, and/or etc. With all available MDT mechanisms and configurations in status quo, the MDT tasks may always be conducted following or subject to UE ongoing service and mobility, for example but not limited to, a UE may not initiate dedicated new service or new mobility profile for MDT purposes but just perform MDT tasks in associated manner. The UE that is capable of performing MDT may be always in passive role and be awaiting the MDT executor selection by the NW, for example but not limited to, a UE that volunteers for a MDT task may not be selected or configured by the NW in a proper service and/or in a proper mobility context.

The present disclosure describes various embodiments for configuring a user equipment (UE) for minimization of drive test (MDT), addressing at least one of the problems/issues discussed above. The present disclosure may enhance MDT mechanism and configuration of selecting and configuring UE with various MDT tasks, improving a technology field in the wireless communication.

FIG. 1B shows a schematic diagram for a NW to select and configure a proper UE for expected MDT tasks. The NW may include a CN 180 and/or a RAN node 185. The CN 180 and/or the RAN node 185 may communicate with an operation and maintenance (OAM) including a trace collection entity (TCE) 170 via for a signaling based MDT 173 and/or a management based MDT 178, respectively. The CN 180 may communicate with the RAN node 185 via a NW interface 183. The RAN node 185 may communicate with a target UE 190 via an air interface 188.

In the classic cellular mobile systems such as 4G Long Term Evolution-Advanced (LTE-A) and 5G New Radio (NR), the MDT feature may be implemented to replace or supplement the legacy costly manual driving test. The LTE-A system may introduce a series of (enhanced) MDT features, and the NR system may introduce a series of (enhanced) MDT features. For both LTE-A and NR systems, the NW (e.g., CN or RAN) may select and configure one or more proper target UE(s) to perform various kinds of MDT tasks against various NW associated objects and/or quantities. The NW may collect and retrieve MDT measurement results from those UEs via signaling radio bearer (SRB) in the air, and may further upload the MDT measurement results (e.g., MDT logs) onto up streamed TCE in the OAM. Based on those MDT measurement results and logs, the NW may analyze and figure out various NW problems and defects so that the NW may further optimize itself in many performance aspects, such as radio coverage, radio capacity, service parameter settings, and etc.

The TCE in OAM 170 may trigger and initiate one or more MDT tasks towards the CN 180 firstly, and then the CN may trigger and initiate the MDT tasks towards a certain RAN node to communicate with a specific target UE. The RAN node 185 may configure the target UE 190 with the one or more particular MDT tasks via SRB in the air. In one implementation, the above procedure may be called signaling based MDT.

In another implementation, the TCE in OAM 170 may trigger and initiate one or more MDT tasks towards a certain RAN node directly but without indicating specific target UE, and then the RAN node may locally select, for example, based on management based MDT PLMN list from user consent information, and may configure a particular target UE with one or more particular MDT tasks via SRB in the air. The above procedure may be called management based MDT. Optionally, in some implementations above, it may be always the NW (CN or RAN) to select the proper UE(s) for expected MDT tasks.

In present MDT mechanism framework, the MDT tasks may always be conducted following or subject to UE ongoing or planned service and mobility of itself, i.e., UE may not initiate dedicated new service or new mobility profile for MDT purposes but just perform MDT tasks in associated manner. For example, in a particular coverage place-A, if there is no UE with a service-X happened there at all, the NW may not get the relevant MDT measurement results for the place-A with the service-X accordingly, and the NW may only configure and get the relevant MDT measurement results with some other UE with service-X in another place-B. Besides, the UE that is capable of MDT may always be in passive role and may be awaiting the MDT executor selection by the NW, i.e., the UE volunteering for the MDT task may not be selected or configured by the NW in a proper service and/or mobility context. For example, in the particular coverage place-A, if there is one volunteer UE with a service-X volunteering to perform a MDT task there, but the NW may not select or configure it with the relevant MDT tasks, so the NW may miss the relevant MDT measurement results for the place-A with the service-X accordingly. In all, it would be more beneficial if the NW is able to configure and get as many expected MDT measurement results as possible with any service and in any place, which may be out of UE's ongoing or planned service and mobility profiles.

The present disclosure describes various embodiments for configuring a user equipment (UE) for minimization of drive test (MDT), addressing at least one of the problems/issues discussed above and/or enhancing MDT mechanism and configuration of selecting and configuring UE with various MDT tasks, improving a technology field in the wireless communication.

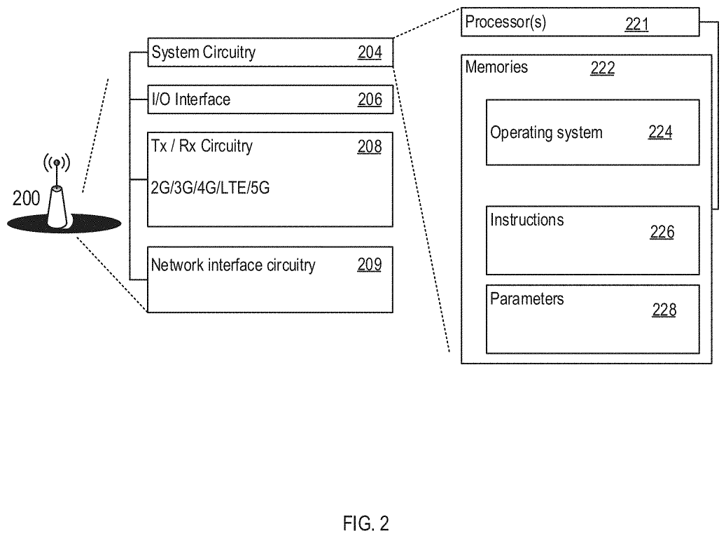

FIG. 2 shows an example of electronic device 200 to implement a network base station (e.g., a radio access network node), a core network (CN), and/or an operation and maintenance (OAM). Optionally in one implementation, the example electronic device 200 may include radio transmitting/receiving (Tx/Rx) circuitry 208 to transmit/receive communication with UEs and/or other base stations. Optionally in one implementation, the electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 221 to perform the functions of the network node. The parameters 228 may include parameters to support execution of the instructions 226. For example, parameters may include network protocol settings, bandwidth parameters, radio frequency mapping assignments, and/or other parameters.

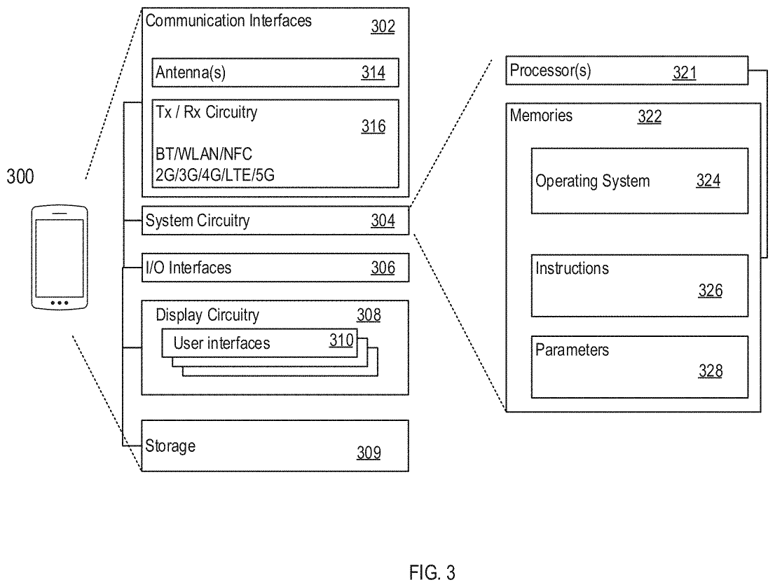

FIG. 3 shows an example of an electronic device to implement a terminal device 300 (for example, a user equipment (UE)). The UE 300 may be a mobile device, for example, a smart phone or a mobile communication module disposed in a vehicle. The UE 300 may include a portion or all of the following: communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes various embodiments for configuring a user equipment (UE) for minimization of drive test (MDT), which may be implemented, partly or totally, on one or more electronic device 200 and/or one or more terminal device 300 described above in FIGS. 2-3.

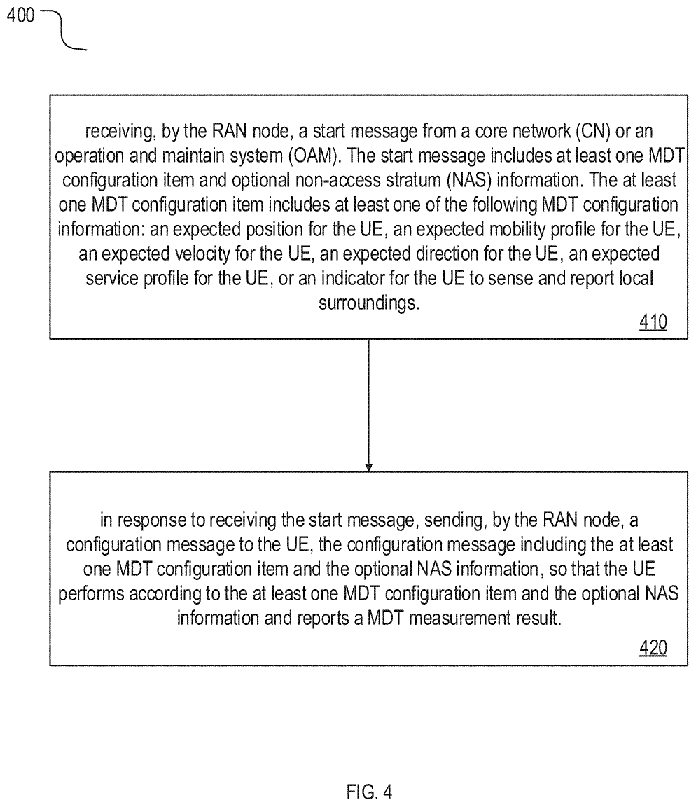

In one embodiment, referring to FIG. 4, a method 400 for wireless communication includes configuring, by a radio access network (RAN) node, a user equipment (UE) for minimization of drive test (MDT). The method 400 may include a portion or all of the following steps.

Step 410 includes receiving, by the RAN node, a start message from a core network (CN) or an operation and maintain system (OAM). The start message includes at least one MDT configuration item and optional non-access stratum (NAS) information. The at least one MDT configuration item includes at least one of the following MDT configuration information: an expected position for the UE, an expected mobility profile for the UE, an expected velocity for the UE, an expected direction for the UE, an expected service profile for the UE, or an indicator for the UE to sense and report local surroundings. In the present disclosure, the word of “optional” means an optional implementation. Here, the NAS information is an optional part in the start message, so that in one implementation, the start message may include at least one MDT configuration item but may not include NAS information; and in another implementation, the start message may include at least one MDT configuration item and include NAS information.

Step 420 includes, in response to receiving the start message, sending, by the RAN node, a configuration message to the UE, the configuration message including the at least one MDT configuration item and the optional NAS information, so that the UE performs according to the at least one MDT configuration item and the optional NAS information and reports a MDT measurement result. In one implementation, the configuration message may include the at least one MDT configuration item but not include the optional NAS information, so that the UE performs according to the at least one MDT configuration item but not the optional NAS information and reports a MDT measurement result. In another implementation, the configuration message may include the at least one MDT configuration item and the NAS information, so that the UE performs according to the at least one MDT configuration item and the NAS information and reports a MDT measurement result.

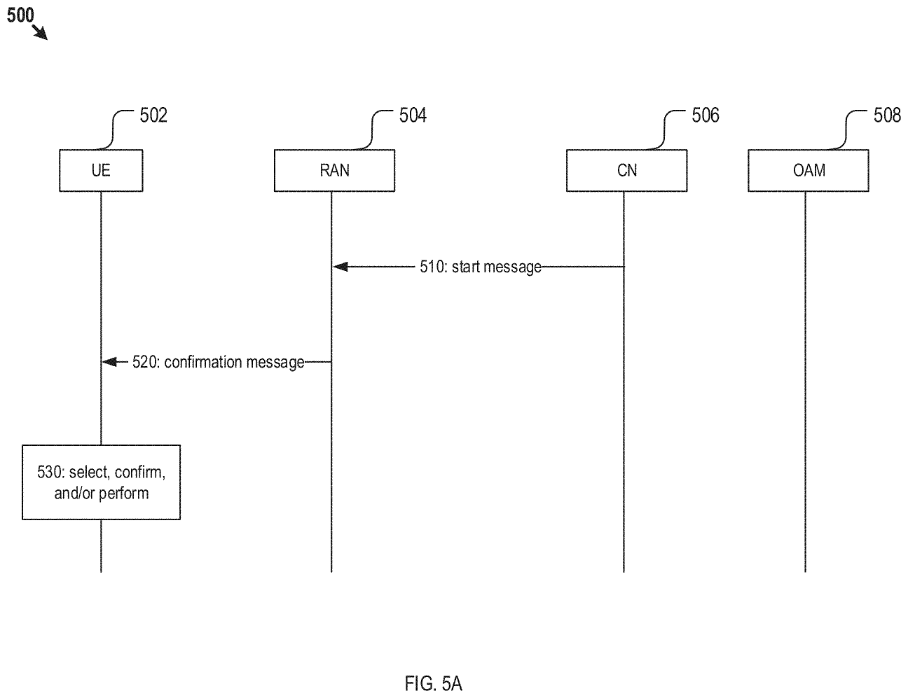

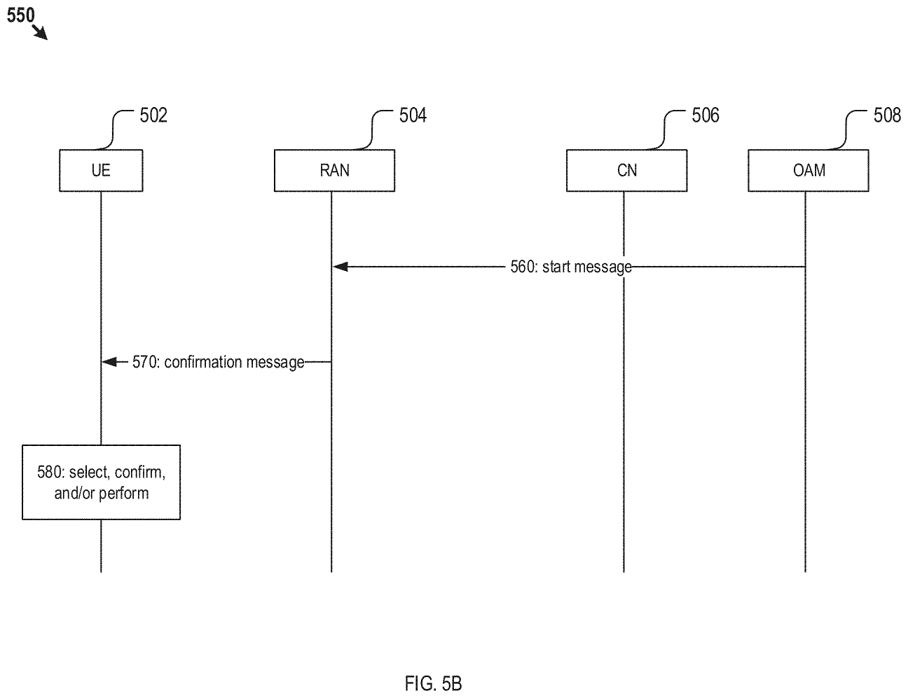

FIGS. 5A and 5B shows exemplary logic flows of the various embodiments for wireless communication.

Referring to FIG. 5A, in a method 500, a CN 506 may send a start message to a RAN 504 (in step 510). Upon receiving the start message, the RAN may compile and send to one or more UE 502 a confirmation message based on the start message (in step 520). Upon receiving the confirmation message, the UE 502 may display a list of tasks on a display of the UE; if there is more than one tasks in the list, a user may select one or more tasks from the list of tasks; the UE may confirm the one or more selected tasks; and/or the UE may start performing based on the selected one or more tasks (in step 530).

Referring to FIG. 5B, in a method 550, an OAM 508 may send a start message to a RAN 504 (in step 560). Upon receiving the start message, the RAN may compile and send to one or more UE 502 a confirmation message based on the start message (in step 570). Upon receiving the confirmation message, the UE 502 may display a list of tasks on a display of the UE; if there is more than one tasks in the list, a user may select one or more tasks from the list of tasks; the UE may confirm the one or more selected tasks; and/or the UE may start performing based on the selected one or more tasks (in step 580).

In one implementation, the start message is transmitted via a NAS procedure so that the at least one MDT configuration item is transparent to the RAN node.

In another implementation, the start message is transmitted via an access stratum (AS) procedure; and in response to receiving the start message, the RAN node compiles and sends the configuration message to the UE.

In another implementation, the RAN node compiles and sends a radio resource control (RRC) message to the UE, the RRC message comprising the configuration message for the UE.

In another implementation, the at least one MDT configuration item comprises at least one of the following: time duration information, or time window information.

In another implementation, upon receiving the configuration message from the RAN node, the UE displays a window comprising the at least one MDT configuration item on a display of the UE; the UE receives a confirmation to one of the at least one MDT configuration item displayed on the display of the UE; and the UE performs according to the one of the at least one MDT configuration item in response to the one of the at least one MDT configuration item being accepted by a user.

Various embodiments may include some present implementations in the present framework and procedures for signaling based MDT and management based MDT. Some of the various embodiment may include a portion or all of existing MDT configurations, for example but not limited to, a MDT Configuration-NR, and/or a MDT Configuration-Evolved Universal Terrestrial Radio Access (EUTRA), and optionally may also include that a NW (e.g., CN and RAN) may provide and configure one or more new MDT configuration information to one or more UE, so that the UE may perform the MDT tasks as expected by the NW with dedicated purposes.

In one implementation, the MDT configuration information may include one or more expected position for the UE. The expected position for the UE comprises at least one of address information or location information, the expected position being obtained from a positioning system; the UE selects one or more target position among the at least one address information or location information according to a user's intention; and/or the UE moves to the one or more target position within a time window.

For example, the expected position (e.g., detailed location information, e.g., Latitude, longitude, Altitude) where a UE needs to go and perform the relevant MDT tasks for configurable time duration. The position information is comparable to what a UE may achieve from any existing Global Navigation Satellite System (GNSS) or Observed Time Difference of Arrival (OTDOA) positioning or alike techniques. The configurable time duration is the time period that UE may stay in that position. Upon receiving above information, the RAN node may forward and configure it to a UE, and the UE may move to or approach the corresponding position to perform the relevant MDT tasks for the time duration.

In another implementation, the MDT configuration information may include one or more expected mobility profile for the UE. The expected mobility profile for the UE comprises a plurality of positions in a time sequence, so that the UE perform the expected mobility profile within a time window by moving to the plurality of positions in the time sequence.

For example, the expected mobility profile (e.g., series of positions in time axis) which UE needs to follow and perform the relevant MDT tasks. The mobility profile information may consist of series of positions as described above and/or corresponding time stamp for each position. The mobility profile may also contain the expected UE velocity information. Upon receiving above information, a RAN node may forward and configure it to a UE, and the UE may follow the corresponding mobility profile and in certain velocity to perform the relevant MDT tasks.

In another implementation, the MDT configuration information may include one or more expected velocity for the UE. The expected velocity for the UE comprises speed information, so that the UE maintains the speed information for a time duration.

For example, the expected velocity (e.g., UE speed information, e.g., 60 kilometer per hour (km/h) or 120 km/h) where a UE needs to follow and perform the relevant MDT tasks for configurable time duration. The velocity information may be comparable to what the UE can achieve from any existing local speed sensor techniques. The configurable time duration is the time period that UE may maintain that velocity during MDT tasks. Upon receiving above information, a RAN node may forward and configure it to a UE, and the UE may move in the expected velocity as much as possible to perform the relevant MDT tasks for the time duration.

In another implementation, the MDT configuration information may include one or more expected direction for the UE. The expected direction for the UE comprises at least one of a moving direction or a UE-orientation direction, so that the UE maintains at least one of the moving direction or the UE-orientation direction for a time duration.

For example, the expected direction (e.g., orientation information, e.g., a UE or a user of the UE facing towards an east direction or a west direction) where a UE needs to maintain and perform the relevant MDT tasks for configurable time duration. The direction information may be comparable to what a UE may achieve from any existing local orientation sensor techniques. The configurable time duration is the time period that a UE may maintain that direction during MDT tasks. Upon receiving above information, a RAN node may forward and configure it to a UE, and the UE may maintain the expected direction or orientation as much as possible to perform the relevant MDT tasks for the time duration.

In another implementation, the MDT configuration information may include one or more expected service profile for the UE. The expected service profile for the UE comprises at least one of a mobile user service or an application, so that the UE performs the expected service profile for a time duration.

For example, the expected service profile (e.g., a set of mobile user services, e.g., beared by DRBs) with which a UE needs to initiate and perform relevant MDT tasks for configurable time duration. The service may not be an ongoing service or planned service by a user of itself, but may be initiated without user original interest and dedicated for MDT purpose. The configurable time duration is the time period that UE may maintain that service profile. Upon receiving above information, a RAN node may forward and configure it to a UE, and the UE may initiate and maintain the expected services to perform the relevant MDT tasks for the time duration.

In another implementation, the MDT configuration information may include one or more indicator for the UE to sense and report local surroundings. The indicator for the UE to sense and report local surroundings comprises at least one of local traffic information or local environment information, so that the UE senses the at least one of the local traffic information or the local environment information for a time duration.

For example, the indicator to indicate a UE to measure/sense its local traffic or environment situation (e.g., car density along the street, population density, surrounding building/trees, etc.), with which a UE needs to perform the relevant MDT tasks and sense the local traffic or environment situation for configurable time duration.

In another implementation, the MDT configuration information may include any one or more of the any kinds of MDT configuration information described above. In one implementation, a CN may forward and configure them to a UE via a NAS procedure directly, i.e., the new MDT configuration information may be transparent to a RAN.

In another implementation, the MDT configuration information may include any one or more of the any one or more kinds of MDT configuration information described above. In one implementation, a CN may forward and configure them to a serving RAN node firstly, and then the RAN node may compile and forward and configure them to UE via AS (e.g., RRC) procedure secondly.

In one embodiment for configuring a user equipment (UE) for minimization of drive test (MDT), the at least one MDT configuration item comprises an expected position and a time duration; and the NAS information comprises NAS level associated information related to at least one MDT task.

In one implementation, the CN sends a new generation application protocol (NGAP) trace start message (e.g., a NGAP TRACE START message) to the RAN node, the NGAP trace start message comprising the start message; in response to receiving the NGAP trace start message, the RAN node compiles and sends a RRC reconfiguration message (e.g., a RRC RECONFIGURATION message) to the UE, the RRC RECONFIGURATION message comprising the configuration message for the UE; in response to receiving a confirmation, the UE moves to the expected position, completes the at least one MDT task, and stays at the expected position for the time duration; and/or the UE reports corresponding MDT measurement results to the RAN node.

In another implementation, the CN may send a NGAP INITIAL CONTEXT SETUP REQUEST message to the RAN node. The NGAP INITIAL CONTEXT SETUP REQUEST may include the start message. In response to receiving the NGAP INITIAL CONTEXT SETUP REQUEST message, the RAN node may compile and send a RRC reconfiguration message (e.g., a RRC RECONFIGURATION message) to the UE, and the RRC RECONFIGURATION message may include the configuration message for the UE. In response to receiving a confirmation, the UE moves to the expected position, completes the at least one MDT task, and stays at the expected position for the time duration; and/or the UE reports corresponding MDT measurement results to the RAN node.

In another implementation, the at least one MDT task comprises a downloading service for a target file in a server.

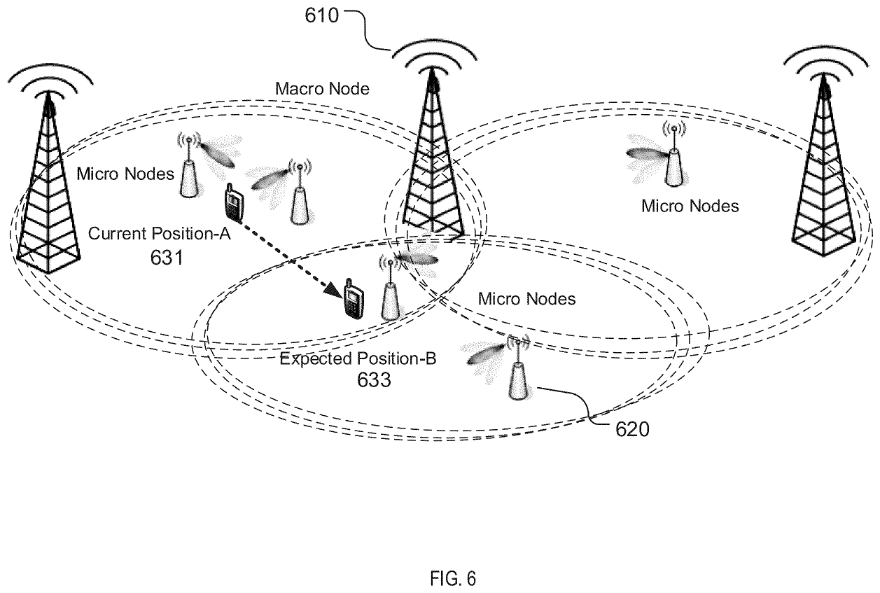

For example as shown in FIG. 6, a 5G HetNet consists of one or more macro RAN nodes 610 and one or more micro RAN nodes 620 to adapt a coverage and/or capacity requirement in a certain serving area. A user (e.g., Tom) may be volunteering to perform one or more MDT tasks per his specific subscriber contract with the mobile operator. Tom with his terminal device (e.g., a smart phone) is currently in position-A 631. The terminal device may communicate with the NW (e.g., CN and RAN) in an RRC_Connected state. The NW may expect Tom (or any other volunteer) to perform one or more certain MDT tasks, e.g., a measurement of a radio coverage and a peak data rate with a file downloading in a position-B 633.

An exemplary procedure for configuring a UE for MDT is described below. The procedure in various embodiments may include a portion or all the following steps, wherein the steps may be performed in the order described below or in a different order.

Step 11: A 5G CN (5GC) sends a NGAP: TRACE START message to a RAN node serving “Tom” at the moment, including the MDT configuration information for the purpose of measuring radio coverage and peak data rate. Besides the normal MDT configuration information, it may contain a new IE “expected position information”, which may include a value of position-B, and a new IE “configurable time duration”, which include a value of 1 minute (Min.). In addition, 5GC may send NAS information in the TRACE START message to a UE in parallel, indicating “Tom” to initiate downloading service for specific target file in the server.

Step 12: Upon receiving the NGAP: TRACE START message, the RAN node compiles and sends the relevant MDT configuration information and optional NAS information to a UE of “Tom” via a RRC RECONFIGURATION message.

Step 13: Upon receiving the RRC RECONFIGURATION message, the UE of “Tom” obtains the MDT configuration information and the optional NAS information, so knowing that the NW expects to perform the specific MDT tasks for measuring radio coverage and peak data rate with file downloading in the expected position-B.

Step 14: “Tom” may move to the expected position-B in his most convenience and start performing the expected MDT tasks for measuring radio coverage and peak data rate with file downloading in the position-B for 1 minute as configured by the NW.

Step 15: The UE of “Tom” may report the corresponding MDT measurement results (or MDT logs) when available via legacy procedures to the NW.

In another embodiment for configuring a user equipment (UE) for minimization of drive test (MDT), the at least one MDT configuration item comprises an expected mobility profile, wherein the expected mobility profile comprises more than one pairs of positions and time sequences; and the NAS information comprises NAS level associated information related to at least one MDT task.

In one implementation, the CN sends a new generation application protocol (NGAP) trace start message to the RAN node, the NGAP trace start message comprising the start message; in response to receiving the NGAP trace start message, the RAN node compiles and sends a RRC reconfiguration message to the UE, the RRC reconfiguration message comprising the configuration message for the UE; in response to receiving a confirmation, the UE follows the expected mobility profile and completes the at least one MDT task; and/or the UE reports corresponding MDT measurement results to the RAN node.

In another implementation, the at least one MDT task comprises watching an online video in a server.

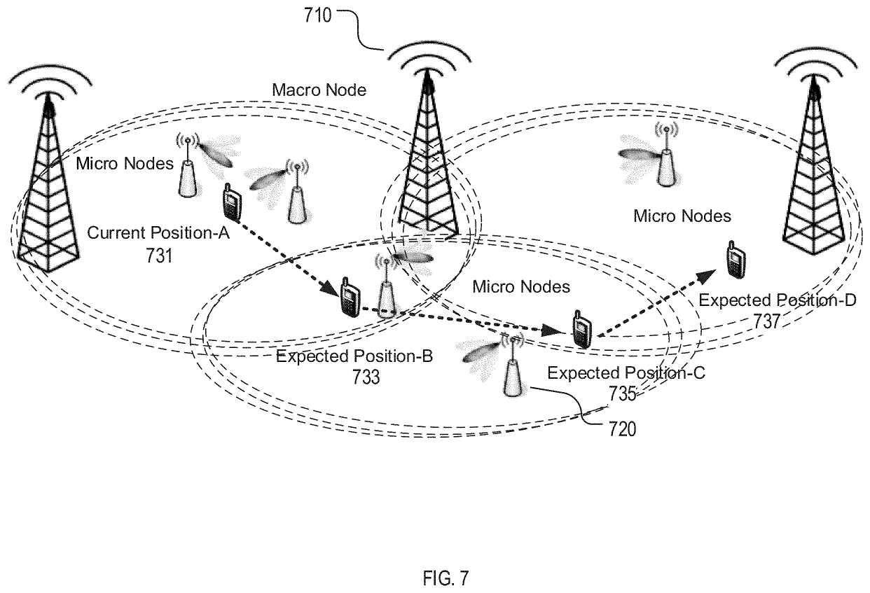

For example as shown in FIG. 7, a 5G HetNet consists of one or more macro RAN nodes 710 and one or more micro RAN nodes 720 to adapt a coverage and/or capacity requirement in a certain serving area. A user “Jack” is volunteering to perform one or more MDT tasks per his specific subscriber contract with the mobile operator, and “Jack” is currently in a position-A 731 and communicating with the NW in an RRC_Connected state. The NW expects “Jack” (or any other volunteer) to perform certain MDT tasks, e.g., measurement of radio coverage and user throughput with watching online videos in the mobility profile, including position-A 731->position-B 733->position-C 735->position-D 734 in a certain velocity.

An exemplary procedure for configuring a UE for MDT is described below. The procedure in various embodiments may include a portion or all the following steps, wherein the steps may be performed in the order described below or in a different order.

Step 21: A 5GC sends a NGAP: TRACE START message to a RAN node serving “Jack” at the moment, including the MDT configuration information for the purpose of measuring radio coverage and user throughput. Besides the normal MDT configuration information, it contains a new IE “expected mobility profile information”, which includes a value of position-A (T0)->position-B (T0+15 Minutes)->position-C (T0+30 Minutes)->position-D (T0+45 Minutes) in certain velocity. In addition, the 5GC may send the NAS information in the TRACE START message to the UE in parallel, indicating “Jack” to initiate watching online videos in the server.

Step 22: Upon receiving the NGAP: TRACE START message, the RAN node compiles and sends the relevant MDT configuration information and optional NAS information to a UE of “Jack” via a RRC RECONFIGURATION message.

Step 23: Upon receiving the RRC RECONFIGURATION message, the UE of “Jack” obtains the MDT configuration information and the optional NAS information, so knowing that the NW expects to perform the specific MDT tasks for measuring radio coverage and user throughput with watching online videos in the expected mobility profile.

Step 24: “Jack” may follow “position-A (T0)->position-B (T0+15 Minutes)->position-C (T0+30 Minutes)->position-D (T0+45 Minutes) in certain velocity” as much as possible in his most convenience and start performing the expected MDT tasks for measuring radio coverage and user throughput with watching online videos in the expected mobility profile as configured by the NW.

Step 25: The UE of “Jack” may report the corresponding MDT measurement results (or MDT logs) when available via legacy procedures to the NW.

In another embodiment for configuring a user equipment (UE) for minimization of drive test (MDT), the at least one MDT configuration item comprises an expected service profile, a time duration, and an expected route profile, wherein the expected route profile comprises more than one pairs of positions and time sequences.

In one implementation, the CN sends a new generation application protocol (NGAP) trace start message to the RAN node, the NGAP trace start message comprising the start message; in response to receiving the NGAP trace start message, the RAN node compiles and sends a RRC reconfiguration message to the UE, the RRC reconfiguration message comprising the configuration message for the UE; in response to receiving a confirmation, the UE follows the expected route profile and performs the expected service profile in the time duration; and the UE reports corresponding MDT measurement results to the RAN node.

In another implementation, the expected service profile comprises performing an X-reality (XR) service and downloading a file from a server simultaneously.

Referring to FIG. 6, a user “Tom” is volunteering to perform MDT tasks per his specific subscriber contract with the mobile operator, and is communicating with the NW in the RRC_Connected state. The NW expects “Tom” (or any other volunteer) to perform MDT tasks of measuring certain service profile, e.g., multiple traffic types online in configurable time duration and in specific route.

An exemplary procedure for configuring a UE for MDT is described below. The procedure in various embodiments may include a portion or all the following steps, wherein the steps may be performed in the order described below or in a different order.

Step 31: The 5GC sends a NGAP: TRACE START message to the RAN node serving “Tom” at the moment, including the MDT configuration information for the purpose of measuring the expected service profile. Besides the normal MDT configuration information, it contains a new IE “expected service profile information”, which includes a value of XR and File downloading service simultaneously in configurable time duration, and/or a new IE “expected route information”, which includes the value of position-A (T0)->position-B (T0+30 Minutes) directly. In addition, 5GC sends the NAS information in the TRACE START message to a UE in parallel, indicating “Tom” to initiate the XR service and file downloading service in the specific time duration from position-A to position-B directly.

Step 32: Upon receiving the NGAP: TRACE START message, the RAN node compiles and sends the relevant MDT configuration information and optional NAS information to the UE of “Tom” via RRC RECONFIGURATION message.

Step 33: Upon receiving the RRC RECONFIGURATION message, the UE of “Tom” obtains the MDT configuration information and the optional NAS information, so knowing that the NW expects to perform the specific MDT tasks for measuring XR service and file downloading service simultaneously in the expected time duration and route line from position-A to position-B.

Step 34: “Tom” may move to the expected position-B from position-A as indicated and start performing the expected MDT tasks for measuring and logging the service relevant KPI such as average data rate, jitter, latency, and/or etc., for each service.

Step 35: The UE of “Tom” may report the corresponding MDT measurement results (or MDT logs) when available via legacy procedures to the NW.

In another embodiment for configuring a user equipment (UE) for minimization of drive test (MDT), the at least one MDT configuration item comprises an indicator for the UE to sense and report a local traffic situation, wherein the local traffic situation comprises at least one of a vehicle speed or a vehicle density.

In one implementation, the CN sends a new generation application protocol (NGAP) trace start message to the RAN node, the NGAP trace start message comprising the start message; in response to receiving the NGAP trace start message, the RAN node compiles and sends a RRC configuration message to the UE, the RRC reconfiguration message comprising the configuration message for the UE; in response to receiving a confirmation, the UE senses the local traffic situation; and/or the UE reports information of the local traffic situation to the RAN node.

For example, in certain downtown area, there are many volunteers of vehicle-to-everything (V2X) users (e.g., one or more UEs capable of various V2X functions) to perform MDT tasks of the mobile operator. They may be communicating with the NW in an RRC_Connected state. The NW expects the volunteers to perform MDT tasks of measuring and reporting traffic situation, e.g., car speed and density along the street via local sensing technique. Based on the report of every volunteer, the NW may get the whole information of the traffic situation in certain area.

An exemplary procedure for configuring a UE for MDT is described below. The procedure in various embodiments may include a portion or all the following steps, wherein the steps may be performed in the order described below or in a different order.

Step 41: The 5GC sends a NGAP: TRACE START message to the RAN node serving the selected volunteer at the moment, including the MDT configuration information for the purpose of measuring traffic situation. Besides the normal MDT configuration information, it contains a new IE “expected report information”, which includes a value of traffic situation report. In addition, the 5GC may send the NAS information in the TRACE START message to the volunteer in parallel, indicating the volunteer to initiate the function of sensing the traffic situation.

Step 42: Upon receiving the NGAP: TRACE START message, the RAN node compiles and sends the relevant MDT configuration information and optional NAS information to the volunteer via RRC RECONFIGURATION message.

Step 43: Upon receiving the RRC RECONFIGURATION message, every volunteer obtains the MDT configuration information and the optional NAS information, so knowing that the NW expects to perform the specific MDT tasks for measuring and reporting the local traffic situation.

Step 44: The volunteer may perform the expected MDT tasks such as measuring the car speed and density to obtain the local traffic situation.

Step 45: The volunteer may report the corresponding MDT measurement results (or MDT logs) when available via legacy procedures to NW.

In another embodiment for configuring a user equipment (UE) for minimization of drive test (MDT), the at least one MDT configuration item comprises an indicator for the UE to sense and report an local environment situation, wherein the local environment situation comprises at least one of a local population density or a surrounding obstacle.

In one implementation, the CN sends a new generation application protocol (NGAP) trace start message to the RAN node, the NGAP trace start message comprising the start message; in response to receiving the NGAP trace start message, the RAN node compiles and sends a RRC reconfiguration message to the UE, the RRC reconfiguration message comprising the configuration message for the UE; in response to receiving a confirmation, the UE senses the local environment situation; and/or the UE reports information of the local environment situation to the RAN node.

In another implementation, the surrounding obstacle comprises at least one of a surrounding building or a surrounding tree.

In certain downtown area, there are many volunteers willing to perform MDT tasks for the mobile operator. They are communicating with the NW in an RRC_Connected state. The NW expects the volunteers to perform MDT tasks of measuring and reporting their local environment situation, e.g., the population density in certain area, and distribution of surrounding buildings/trees via local sensing technique. Based on the environment situation report, the NW gets the whole environment situation in certain area.

An exemplary procedure for configuring a UE for MDT is described below. The procedure in various embodiments may include a portion or all the following steps, wherein the steps may be performed in the order described below or in a different order.

Step 51: The 5GC sends a NGAP: TRACE START message to the RAN node serving the selected volunteer at the moment, including the MDT configuration information for the purpose of measuring environment situation. Besides the normal MDT configuration information, it contains a new IE “expected report information”, which includes a value of an environment situation report. In addition, the 5GC may send the NAS information in the TRACE START message to the volunteer in parallel, indicating the volunteer to initiate the function of sensing its environment situation.

Step 52: Upon receiving the NGAP: TRACE START message, the RAN node compiles and sends the relevant MDT configuration information and optional NAS information to the volunteer via an RRC RECONFIGURATION message.

Step 53: Upon receiving the RRC RECONFIGURATION message, every volunteer obtains the MDT configuration information and the optional NAS information, so knowing that the NW expects to perform the specific MDT tasks for measuring and reporting its environment situation.

Step 54: The volunteer may perform the expected MDT tasks such as measuring the population density and surrounding buildings/trees to obtain the current environment information.

Step 55: The volunteer may report the corresponding MDT measurement results (or MDT logs) when available via legacy procedures to NW.

The present disclosure may also describes various embodiments for a method of configuring a user equipment (UE) for minimization of drive test (MDT) by receiving, by the UE, a configuration message from a radio access network (RAN) node, the configuration message comprising at least one MDT configuration item and optional non-access stratum (NAS) information. A core network (CN) or an operation and maintain system (OAM) sends a start message to the RAN node, the start message comprising the at least one MDT configuration item and the optional NAS information, in response to receiving the start message from the CN or the OAM, the RAN node sends the configuration message to the UE, and the at least one MDT configuration item comprises at least one of the following MDT configuration information: an expected position for the UE, an expected mobility profile for the UE, an expected velocity for the UE, an expected direction for the UE, an expected service profile for the UE, or an indicator for the UE to sense and report local surroundings. The method may also include performing, by the UE, according to the at least one MDT configuration item and the optional NAS information and reporting a MDT measurement result. The various embodiments may be realized by implementing a portion or all of the previous embodiments.

The present disclosure may also describes various embodiments for a method of configuring, by a core network (CN), a user equipment (UE) for minimization of drive test (MDT) by sending, by the CN, a start message to a radio access network (RAN) node. The start message includes at least one MDT configuration item and optional non-access stratum (NAS) information, and the at least one MDT configuration item includes at least one of the following MDT configuration information: an expected position for the UE, an expected mobility profile for the UE, an expected velocity for the UE, an expected direction for the UE, an expected service profile for the UE, or an indicator for the UE to sense and report local surroundings. In the method, in response to receiving the start message, the RAN node may send a configuration message to the UE, the configuration message comprising the at least one MDT configuration item and the optional NAS information, so that the UE performs according to the at least one MDT configuration item and the optional NAS information and reports a MDT measurement result. The various embodiments may be realized by implementing a portion or all of the previous embodiments.

The present disclosure describes methods, apparatus, and computer-readable medium for wireless communication. The present disclosure addressed the issues with configuring a UE for MDT. The methods, devices, and computer-readable medium described in the present disclosure may facilitate the performance of wireless communication by configuring a UE for MDT, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
configuring, by a radio access network (RAN) node, a user equipment (UE) for minimization of drive test (MDT) by:
receiving, by the RAN node, a start message from a core network (CN) or an operation and maintain system (OAM), the start message comprising at least one MDT configuration item, the at least one MDT configuration item comprising at least one of the following MDT configuration information:
an expected position for the UE,
an expected mobility profile for the UE,
an expected velocity for the UE,
an expected direction for the UE,
an expected service profile for the UE, or
an indicator for the UE to sense and report local surroundings; and
in response to receiving the start message, sending, by the RAN node, a configuration message to the UE, the configuration message comprising the at least one MDT configuration item, so that the UE performs according to the at least one MDT configuration item and reports a MDT measurement result.

2. The method according to claim 1, wherein:
the start message comprises non-access stratum (NAS) information;
the configuration message comprises the NAS information; and
the UE performs according to the at least one MDT configuration item and the NAS information.

3. The method according to claim 1, wherein:
the start message is transmitted via a NAS procedure so that the at least one MDT configuration item is transparent to the RAN node.

4. The method according to claim 1, wherein:
the start message is transmitted via an access stratum (AS) procedure; and
in response to receiving the start message, the RAN node compiles and sends the configuration message to the UE.

5. (canceled)

6. The method according to claim 1, wherein:
the at least one MDT configuration item comprises at least one of the following: time duration information, or time window information.

7. The method according to claim 1, wherein:
upon receiving the configuration message from the RAN node, the UE displays a window comprising the at least one MDT configuration item on a display of the UE;
the UE receives a confirmation to one of the at least one MDT configuration item displayed on the display of the UE; and
the UE performs according to the one of the at least one MDT configuration item in response to the one of the at least one MDT configuration item being accepted by a user.

8. The method according to claim 1, wherein:
the expected position for the UE comprises at least one of address information or location information, the expected position being obtained from a positioning system;
the UE selects one or more target position among the at least one address information or location information according to a user's intention; and
the UE moves to the one or more target position within a time window.

9. The method according to claim 1, wherein:
the expected mobility profile for the UE comprises a plurality of positions in a time sequence, so that the UE perform the expected mobility profile within a time window by moving to the plurality of positions in the time sequence.

10. The method according to claim 1, wherein:
the expected velocity for the UE comprises speed information, so that the UE maintains the speed information for a time duration.

11. The method according to claim 1, wherein:
the expected direction for the UE comprises at least one of a moving direction or a UE-orientation direction, so that the UE maintains at least one of the moving direction or the UE-orientation direction for a time duration.

12. The method according to claim 1, wherein:
the expected service profile for the UE comprises at least one of a mobile user service or an application, so that the UE performs the expected service profile for a time duration.

13. The method according to claim 1, wherein:
the indicator for the UE to sense and report local surroundings comprises at least one of local traffic information or local environment information, so that the UE senses the at least one of the local traffic information or the local environment information for a time duration.

14-19. (canceled)

20. The method according to claim 1, wherein:
the at least one MDT configuration item comprises an expected service profile, a time duration, and an expected route profile, wherein the expected route profile comprises more than one pairs of positions and time sequences.

21. (canceled)

22. (canceled)

23. The method according to claim 1, wherein:
the at least one MDT configuration item comprises an indicator for the UE to sense and report a local traffic situation, wherein the local traffic situation comprises at least one of a vehicle speed or a vehicle density.

24. (canceled)

25. The method according to claim 1, wherein:
the at least one MDT configuration item comprises an indicator for the UE to sense and report an local environment situation, wherein the local environment situation comprises at least one of a local population density or a surrounding obstacle.

26-33. (canceled)

34. An apparatus comprising:
a memory storing instructions; and
a processor in communication with the memory, wherein, when the processor executes the instructions, the processor is configured to cause the apparatus to perform configuring a user equipment (UE) for minimization of drive test (MDT) by:
receiving a start message from a core network (CN) or an operation and maintain system (OAM), the start message comprising at least one MDT configuration item, the at least one MDT configuration item comprising at least one of the following MDT configuration information:
an expected position for the UE,
an expected mobility profile for the UE,
an expected velocity for the UE,
an expected direction for the UE,
an expected service profile for the UE, or
an indicator for the UE to sense and report local surroundings; and
in response to receiving the start message, sending a configuration message to the UE, the configuration message comprising the at least one MDT configuration item, so that the UE performs according to the at least one MDT configuration item and reports a MDT measurement result.

35. The apparatus according to claim 34, wherein:
the start message comprises non-access stratum (NAS) information;
the configuration message comprises the NAS information; and
the UE performs according to the at least one MDT configuration item and the NAS information.

36. The apparatus according to claim 34, wherein:
the start message is transmitted via a NAS procedure so that the at least one MDT configuration item is transparent to the apparatus.

37. A non-transitory computer program product comprising a computer-readable program medium storing instructions, wherein, the instructions, when executed by a processor, are configured to cause the processor to perform configuring a user equipment (UE) for minimization of drive test (MDT) by:
receiving a start message from a core network (CN) or an operation and maintain system (OAM), the start message comprising at least one MDT configuration item, the at least one MDT configuration item comprising at least one of the following MDT configuration information:
an expected position for the UE,
an expected mobility profile for the UE,
an expected velocity for the UE,
an expected direction for the UE,
an expected service profile for the UE, or
an indicator for the UE to sense and report local surroundings; and
in response to receiving the start message, sending a configuration message to the UE, the configuration message comprising the at least one MDT configuration item, so that the UE performs according to the at least one MDT configuration item and reports a MDT measurement result.

38. The computer program product according to claim 37, wherein:
the start message comprises non-access stratum (NAS) information;
the configuration message comprises the NAS information; and
the UE performs according to the at least one MDT configuration item and the NAS information.
